(19) United States
(12) Patent Application Publication
(10) Pub. No.: US 2004/0264368 A1
(43) Pub. Date: Dec. 30, 2004

(54) Data transfer optimization in packet data networks

(75) Inventors: Hilkka Heiskari, Vantaa (FI); Juan Bernabeu, Tallinn (EE); Miikka Huomo, Vantaa (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/641,093

(22) Filed: Aug. 15, 2003

(30) Foreign Application Priority Data
Jun. 30, 2003 (EP) 03014857.1

(51) Int. Cl. H04L 12/28

(52) U.S. Cl. 370/229

(57) ABSTRACT

A method for data transport optimization in a telecommunication network, in particular, for implementation in a packet switched telecommunication network. The network typically includes at least a first access node, which usually provides access to the telecommunication network. At least a first optimization node, typically including a performance enhancement proxy functionality, is commonly located between a core of the telecommunication network and the at least first access node. Data is generally sent at least from the core in the direction of the at least first access node, from which the data is then typically sent to at least a first client having access to the telecommunication network, usually via an access link to the access node. The access link normally has a varying data transport capacity. Also, a network element generally useful for implementing the method.

### BACKGROUND OF THE INVENTION

1. Field of the Invention

The present application relates generally to methods for data transport optimization in a communication network and, also, to network elements for data transport optimization in, for example, communication networks.

The present application also generally relates to methods for data transport optimization in communication networks, usually by transfer of certain flow control information from access networks to traffic-optimizing nodes.

2. Description of the Related Art

Modern telecommunication networks are generally developing more and more from mere communication means, in other words, commonly carrying voice signals from a user A to a user B, or vice versa, towards networks providing multimedia services. This is also possibly the result of the merger of stand-alone information processing means, for example, personal digital assistants (PDA), with telecommunications means, such as, but not limited to, mobile phones. Therefore, telecommunication networks nowadays commonly transmit a mass of digital data, which can usually be of any kind, for example, the afore-mentioned digitalized voice data and multimedia data typically including digitalized visual as well as audio information.

However, a usually crucial aspect of this network data transport is that different applications running on user terminals normally have different needs concerning the rate by which the network should deliver the data. Providing a certain standard of quality typically requires a certain minimum data transmission rate, especially in cases where the data processing runs in real time. Since network capacity will generally always be a limiting factor, network operators commonly apply controlling measures which usually aim for the optimum in trade off between giving the single user the highest possible data transmission rates according to his needs and providing service to all accessing users. Therefore, data transport optimization is normally important in any modern telecommunication network and even the smallest effort that brings enhancement to the end user experience is usually very much welcomed by network operators.

There are generally two major classes of telecommunication networks: circuit switched networks and packet switched networks. In circuit switched networks, for the communication, a certain circuit is normally established prior to the beginning of the data transmission. Thus, information about the destination of the sent data is typically included in the assigned circuit identity. This approach is generally advantageous from a user's point of view, since the whole capacity of the circuit in question typically belongs to the user. However, when the circuit is reserved even when there is no information to be sent, for example, in a voice call when nobody is talking, such a network capacity allocating technique is usually wasting network capacity.

In connectionless packet switched networks, the transmission network paths are usually common to all users. The data is commonly sent in packets and, thus, all packets typically contain information about their destination. There is generally no need to allocate transmission resources for the communication prior to the beginning of the transmission. Since no packets are transmitted when there is no information to be sent, network capacity is normally not reserved in vain. Based on the information about the destination included in the packet, every network element typically routes the packet to the next network element. Moreover, all packets sent during a communication from a user A to a user B need not necessarily travel via the same route in the network.

In connection orientated packet switched techniques, establishing virtual circuits is generally known to those skilled in the art. A virtual circuit usually includes predetermined legs between network elements, along which every packet in a certain connection is normally routed. Thus, the data is typically routed similarly to circuit switched networks. However, the communication capacity of a virtual circuit is usually not reserved exclusively to two communicating parties. Thus, if there is no data to be sent, it is generally the case that no network capacity is wasted at all. Every packet normally includes information about its virtual circuit, and every network element of the virtual circuit typically holds context information, which usually specifies where to route a packet with a known virtual circuit to and what identifiers to use on the next leg.

Modern radio access networks frequently combine both virtual circuit switching and connectionless packet switching such that, in the radio access part of the networks, virtual circuit switching is generally applied. An example of such a telecommunication network utilizing virtual circuits is the general packet radio service (GPRS), which is specified by European Telecommunication Standards Institute (ETSI).

The basic structure of a representative GPRS network is depicted in FIG. 1, wherein the representative network is focused on the paths where the data typically flows. The elements shown include serving GPRS support nodes (SGSN1, SGSN2), gateway GPRS support nodes (GGSN1, GGSN2), and the base station subsystem, generally including base station controllers (BSC1, BSC2) and, commonly, many base stations (BS1, BS2, BS3, BS4), which commonly build the radio access cells (CELL1, CELL2, CELL3, CELL4) of the radio access network. There are normally connections to a core network, for example, the Internet, using the Internet protocol (IP), to which somewhere a content server (CONTENT) is typically connected. Additionally, the GPRS network often includes a home location register (HLR) which commonly keeps, for instance, information about the subscriber services. The subscriber generally has access to the GPRS network via a mobile station (MS) as client device.

The MS is normally located in the cell with the cell identifier or CELL ID CELL1, and every packet directed to or sent by the MS is usually transmitted through same BS, BS1, same BSC, BSC1, same SGSN, SGSN2, and/or same GGSN, GGSN2. In FIG. 1, dotted arrows depict the typical path of the data packets from the MS to the content server CONTENT, and vice versa. The MS generally cannot establish a connection to a GGSN if the used SGSN does not hold context information for this MS. The MS commonly communicates with the base station BS1 through a radio interface. Between the BS1, BSC1, and the SGSN2, a virtual connection is typically established, and all packets are normally transmitted along this route. In the connectionless packet switched network using the Internet protocol (IP) between the SGSN and the GGSN, the transmission of different packets may use different routes.

The link between the mobile MS and the SGSN is almost always uniquely identified by a routing area RA which, for the purpose of clarity, is not shown, and a temporary logical link identity (TLLI). Routing areas usually include one or several cells. GPRS mobility management (MM) routinely uses routing areas as location information for mobiles in standby state, in which the mobile typically has no active connection. The TLLI commonly identifies a connection unambiguously within one certain routing area. A mobile may have multiple simultaneous connections, usually using different protocols, for example, X.25 and IP. Connections using different protocols are generally discriminated using a network service access point identifier (NSAPI).

The application layer in the MS normally sends a subnetwork dependent convergence protocol (SNDCP) layer a packet data protocol packet data unit (PDP PDU), which may be, for instance, an IP packet. In the SNDCP layer, the PDU is typically encapsulated in an SNDCP packet, in the header of which the NSAPI is commonly indicated. The resulting SNDCP packet is usually sent to the logical link control (LLC) layer and the TLLI is normally included in the LLC header. Then, the LLC frames are commonly carried over the air interface, typically by the radio link control (RLC) protocol to the BS/BSC and/or between the BSC and SGSN by the base station subsystem GPRS protocol (BSSGP). For downlink packets, the base station subsystem (BSS) normally checks the cell identity indicated in the BSSGP header, and typically routes the packets to the appropriate BS. For the uplink packets, the BSC usually includes the BSSGP header, the cell identity of the MS based on the source BS.

Between the SGSN and GGSN, the SGSN and GGSN addresses and a tunnel identifier TID, which normally identifies the connection in the GGSN and in the SGSN, commonly identify the link. On the link between the SGSN and the GGSN, the GPRS tunneling protocol (GTP) is generally used. Thus, GPRS is a system where virtual connections are often used between MS and GGSN. These virtual connections generally include two separated links, for example, the MS-SGSN link and the SGSN-GGSN link. The MS and the GGSN are not generally able to communicate with each other if they are not using an SGSN holding context information for the MS.

In the following way, data packets from the MS, in other words, mobile originated (MO) packets, and data packets to the MS, in other words, mobile terminated (MT) packets, are briefly explained. For MO packets, the MS commonly sends the BSS a data packet, normally containing the TLLI, NSAPI, and/or the user data. On the link between MS and SGSN, the SNDCP protocol and LLC protocol is often used. In a simple implementation, one BSC is generally always using the same SGSN and, therefore, its function is typically to route the packets between many BS's and the one SGSN. In a more complicated representative implementation, the BSC is normally connected to a plurality of SGSN's and its further function is commonly to identify the right SGSN, usually with help of the TLLI. In such an implementation, the MS, BS, SGSN, and/or GGSN all normally hold context information necessary to route the packets belonging to the connection. This information is generally stored in a look-up table in the BSS.

Each SGSN typically holds context information about each mobile station it handles. In GPRS, the context information may be divided into mobility management (MM) and packet data protocol (PDP) context parts. In many instances, the MM part provides information related to where the MS is located and/or in which state, in other words, idle, standby, ready, etc., it is. In addition, the MM part typically is common for all the different packet data services using different protocols. The PDP part generally provides information specific for the service in question and usually includes, for example, routing information and/or a PDP address used. Based on the context information, the SGSN typically maps the identification TLLI and/or NSAPI used in the link between the SGSN and the MS to GGSN address and TID, which commonly identifies the connection between the SGSN and the GGSN. The GGSN routinely sends the PDP PDU to the packet data core network, in other words, in FIG. 1, the Internet.

For MT packets, the GGSN normally knows which SGSN handles the connection of the MS and the TID, which usually identifies the connection in the SGSN. Thus, the packet is generally sent to the SGSN handling the MS, and the SGSN typically derives from the TID the TLLI, the NSAPI, the routing area identification RA and, if already known, the cell identifier. Based on this, the SGSN can usually send the packet to the right BSS. Using the TLLI, routing area and/or cell identity, the BSS can usually transfer the packets to the right MS. NSAPI is normally needed in the MS in order to be able to discriminate between different packet data protocols.

The transmission control protocol (TCP) is often used as the transport layer protocol by many Internet and intranet applications. However, in certain environments, TCP and/or other higher layer protocol performance is often limited by the link characteristics of the environment. For instance, it may occur, due to back-to-back arriving TCP acknowledgements (ACK), that the performance of a link is decreased since bursts of TCP data segments are stuck in the data channel. Further, since data segments may be lost on a network path, for example, due to errors and/or packet dropping, then those data segments usually have to be retransmitted. Therefore, on links with a high bit error rate (BER), it happens that most of the link capacity is commonly wasted for retransmission. In radio access networks (RAN), the air interface, in other words, the access link of the network, is usually a radio connection and is generally the most crucial path where the data flow commonly suffers from downgraded link data transport capacity. Moreover, this typically has high impact on the quality experienced by the end-user.

A known procedure that is usually directed on the air interface data transport capacity is the flow control of the base station subsystem GPRS protocol (BSSGP). BSSGP flow control generally tries to keep BSC from overloading. SGSN typically controls the data flow by buffering data packets, in case those cannot be sent to BSC. SGSN normally drops packets, in other words, utilizes RED, if the buffers fill too much. However, packet dropping is generally not the desired alternative to preempt congestion.

It is generally known to use a performance enhancement proxy (PEP) to improve performance of the Internet protocol (IP) on network paths where native performance suffers, usually due to characteristics of a network link and/or a subnetwork on the path. Such PEP normally would try to optimize the data transfer. However, at least in the afore-described environment, it is often very difficult, usually since the PEP would not normally know even estimates of, for instance, the possible mobile station's data leak rate. In addition, data leak rate often changes and/or varies much due to congestion situations in the radio access network. For example, at one point in time, MS may experience 30 kbit/s throughput and/or data transport capacity. However, in the very next moment, the call server (CS) side may “steal” all time slots (TSL) from the cell and MS data throughput may be decreased to zero.

It is therefore an object of certain embodiments of the present invention to provide methods for data transport optimization in a telecommunication network which typically help to increase effective data throughput from the network to a client which, according to certain embodiments, is a mobile client connected to the network via a radio access link, in other words, a radio connection.

It is a further object of certain embodiments of the present invention to provide network elements for data transport optimization which adapt the data flow rate from a telecommunication network towards a client that typically has access to the network via a radio access connection with respect to an actual data transport capacity of the radio access connection.

### SUMMARY OF THE INVENTION

A goal of certain embodiments of the present invention is to optimize the data throughput of a radio access network, in particular, a radio access link, which often has a more or less continuously varying data transport capacity. By using information indicating the actual data transport capacity of the access network and/or the access link for adapting the data flow from the network to the offered data transport capacity of the access network and/or the access link over all the data, throughput in the radio access network is commonly enhanced. The information indicating the actual data transport capacity of the access network and/or the access link is usually transmitted to a network element, which generally includes a performance enhancing proxy (PEP) functionality. For example, such PEP functionality may be incorporated in a gateway network support node and/or an adjacent entity. By sending changed information about the actual data transport capacity of the access network and/or of the access link immediately to the PEP, functionality means that changed situations can normally be dealt with faster. Further, long breaks in data transfer can usually be avoided. In other words, by sending just enough but not too much data to a gateway node of the network, the whole data transfer typically comes closer to the optimum, at least since data drops due to buffer overruns and/or unnecessary retransmission, etc., are normally avoided.

Accordingly, certain embodiments of the present invention provide methods for data transport optimization in a telecommunication network. The network commonly includes at least a first access node, generally for providing access to the telecommunication network, at least a first optimization node, which usually has a performance enhancement proxy functionality. According to certain embodiments, the at least first optimization node is located between a core of the telecommunication network and the at least first access node. Data is normally sent at least from the core of the telecommunication network, usually in the direction of the at least first access node. From the at least first access node, data is normally sent to at least a first client. The client generally has access to the telecommunication network via, for example, an access link to the at least first access node. The access link typically has a varying data transport capacity.

In certain embodiments of the present invention, the access link from the at least first client to the at least first access node includes a radio connection. Due to changing transmitting conditions, congestion situations, etc., the radio connection normally has a varying data transport capacity. In certain other embodiments of the invention, the access link from the at least first client to the telecommunication network is usually an access network, often having a varying data transport capacity, for instance, due to changes in the configuration conditions of the access network.

According to certain embodiments of the present invention, methods for data transport optimization typically include one or more of the following steps: monitoring optimization information consecutively, forwarding the optimization information to the at least first optimization node, and adapting the data flow rate from the core to the access link to the monitored data transport capacity, usually by the performance enhancement proxy functionality in the optimization node. According to certain embodiments of the present invention, the optimization information indicates the actual available data transport capacity of the access link of the at least first client.

In at least one network environment according to certain embodiments of the present invention, the telecommunication network includes a packet switched telecommunication network such as, but not limited to, a general packet radio service (GPRS) network, a code division multiplex access (CDMA) network, a universal mobile telecommunication service (UMTS) network, and/or a wireless local area network (WLAN). According to certain of these embodiments, the at least first client includes a mobile station. The at least first access node is commonly a base station of a base station subsystem, and the coverage area of a base station normally defines a radio access cell. The access link is then typically a radio connection between an at least first mobile station and an at least first base station.

According to certain embodiments of the invention, the at least first optimizing network node is generally a gateway support node, which typically includes the performance enhancement proxy functionality. In certain other embodiments of the Invention, a gateway support node is often located between the base station subsystem and the at least first optimizing network element.

Further, a first serving support node is commonly located between the gateway support node and the base station subsystem.

With respect to certain embodiments of the present invention, since present-day telecommunication networks serving support network nodes already usually receive flow control data from the base station subsystem, where the at least first access node is normally located, in some embodiments of the present invention, the serving support node commonly processes the already forwarded information, which is then generally directed to the performance enhancement proxy functionality. Advantageously, huge changes are typically not needed in order to forward the usually more interesting information to the at least first gateway support node as well.

Certain embodiments of the present invention, in addition, often provide a network element for data transport optimization in a telecommunication network having a performance enhancement proxy functionality and commonly being located between a core of the telecommunication network and an at least first access node of the telecommunication network which is typically arranged for receiving optimization information. The optimization information normally indicates the actual available data transport capacity of the access link. The network element for data transport optimization is generally further arranged for adapting the data flow rate from the core of the telecommunication network directed to the at least a first access link to the actual monitored data transport capacity.

In a first embodiment of the network element according to certain embodiments of the present invention, the network element is typically a gateway support node of a packet switched telecommunication network, for example, a GPRS, a CDMA2000, a UMTS telecommunication network, or a WLAN.

In a second embodiment of the network element according to certain other embodiments of the present invention, the network element is often a performance enhancement proxy, usually located between a core of the telecommunication network and a gateway support node of a packet switched telecommunication network, for example, a GPRS, a CDMA2000, a UMTS telecommunication network, or a WLAN.

In general, by implementation of certain embodiments of the present invention, network operators may achieve clearer network architectures and/or have better performing cores and/or radio networks, in other words, access networks, usually because most of necessary optimization is typically done in another edge of the networks, in other words, in the GGSN itself and/or in an adjacent node, such as, but not limited to, the PEP. Further, the data transport optimization according to certain embodiments of the present invention often provides more alternatives for the telecommunication network to deal with congestion. For example, it has generally been demonstrated by the inventors that, for instance, TCP flows achieve much better throughput if congestion is visible in advance and/or data flows can be adjusted to changed situation beforehand.

There are also typically many advantages of certain embodiments of the present invention for end-users having access to the telecommunication network, which are usually the network operator's customers: Due to the typical enhancement of the data transport in the access network, the end-user, in other words, clients, will often experience a faster access time to content servers. Also, faster download time of content will commonly be enabled by the higher throughput, especially when the data rate is adjusted to network changes more quickly according to certain embodiments of the present invention. Moreover, fewer disturbances with online real-time streaming content will generally be experienced by the end-user. Moreover, it is commonly possible to have cheaper fees if network operators use a charging model, which is generally based on the utilized airtime and/or utilized volume.

There are also many advantages provided by certain embodiments of the present invention which are especially interesting for the telecommunication network operators: Since unnecessary retransmission, normally at TCP or higher layers, can generally be avoided, the effectiveness of the data transport in the network is usually increased. Further, faster access and/or faster download time normally means more available airtime for other end-users. In other words, more users can often be served with the same available data transport capacity of the access network. Furthermore, compressed data rate is usually adapted quickly to network changes, which typically means that the operator does not generally need to over-dimension to keep the end-user's perceived quality of service at an acceptable level, in other words, saving in investments into new network elements. Moreover, certain embodiments of the present invention routinely provide an integrated solution where information about the access network condition is commonly transferred quickly to GGSN or PEP, which, for instance, may be implemented with software upgrades. In other words, there is usually no need to invest in external nodes to gather the needed optimization information.

The above and other objectives, features, and/or advantages of certain embodiments of the present invention will become clearer from the following description of the preferred embodiments thereof, taken in conjunction with the accompanying drawings. In the drawings, similar or equivalent parts retain the same reference number. All drawings are generally intended to illustrate some aspects and embodiments of the present invention. Moreover, when different embodiments are presented, only the differences are typically described in detail. It is to be understood that not all alternatives and/or options of the embodiments of the present invention are shown and, therefore, the present invention is not limited to the content of the accompanying drawings.

### BRIEF DESCRIPTION OF THE DRAWINGS

In the following, certain embodiments of the present invention will be described, usually in detail, by way of example with reference to the accompanying drawings, in which:

FIG. 1 shows the basic structure of a representative GPRS network, in particular, the radio access portion thereof, where methods and/or network elements according to certain embodiments of the present invention may be implemented;

FIG. 2 depicts an embodiment of an implementation of the traffic optimization functionality according to certain embodiments of the present invention, and shows in detail, in the bottom portion of FIG. 2, the network layers of representative in data flow participating network elements; and

FIG. 3 is a processing and signaling diagram showing the basic optimization information transfer from a representative BSC through a 2G-SGSN to a GGSN according to certain embodiments of the present invention.

### DETAILED DESCRIPTION OF THE PREFERRED EMBODIMENT(S)

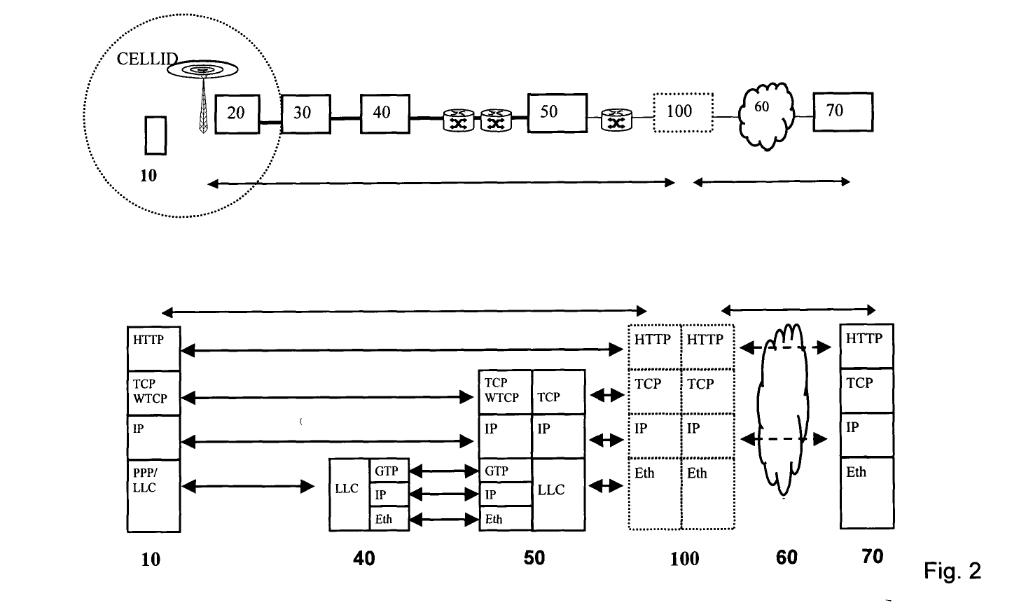

In FIG. 2, the general direction of the data flow from and to a user terminal in a telecommunication network, in particular where the user terminal is a mobile station 10 connected to the telecommunication network via a radio access network, is now explained. In the bottom portion of FIG. 2, there are depicted, in detail, the network elements from the upper portion of FIG. 2. More specifically, the first four layers according to the OSI model are shown. The telecommunication network of the embodiment of the present invention illustrated in FIG. 2 is a general packet radio service (GPRS) telecommunication network.

FIG. 2 shows a connection between a representative mobile station (MS) 10 and a typical content server 70, which is generally connected somewhere to the Internet 60 using the Internet protocol (IP). The IP address of the content server 70 is, for the purpose of this discussion, assumed to be 212.212.212.212. The MS 10 whose IP address is assumed, of the purpose of this discussion, to be 232.232.232.232, is usually connected to base station (BS) 20 via a radio interface. The BS 20 commonly belongs to a routing area RA, which is not shown in FIG. 2.

When the MS 10 sends the content server 70 a mobile originated (MO) IP packet via the GPRS network, the IP packet is usually first encapsulated in a subnetwork dependent convergence protocol (SNDCP) packet, in other words, a data packet according to the SNDCP protocol. Then, the SNDCP packet is commonly put in a logical link control (LLC) frame, usually containing the temporary logical link identity (TLLI), which normally identifies the link between the serving GPRS support node (SGSN) 40 and the MS 10 unambiguously within the routing area RA, and also usually containing the network service access point identifier (NSAPI), which typically specifies the protocol used. The LLC frame is then generally sent to BS 20.

BS 20 is commonly connected to base station controller (BSC) 30. All the packets sent by the MS 10 are usually routed via the BSC 30. When receiving the packet from BS 20, the BSC 30 normally adds to the packet the cell identity CELLID of the cell covered by the BS 20. BSC 30 typically holds information about the particular SGSN, in this case, SGSN 40, to which the packets are generally to be sent. In FIG. 2, it is usually assumed that all packets coming from routing area RA are sent to SGSN 40.

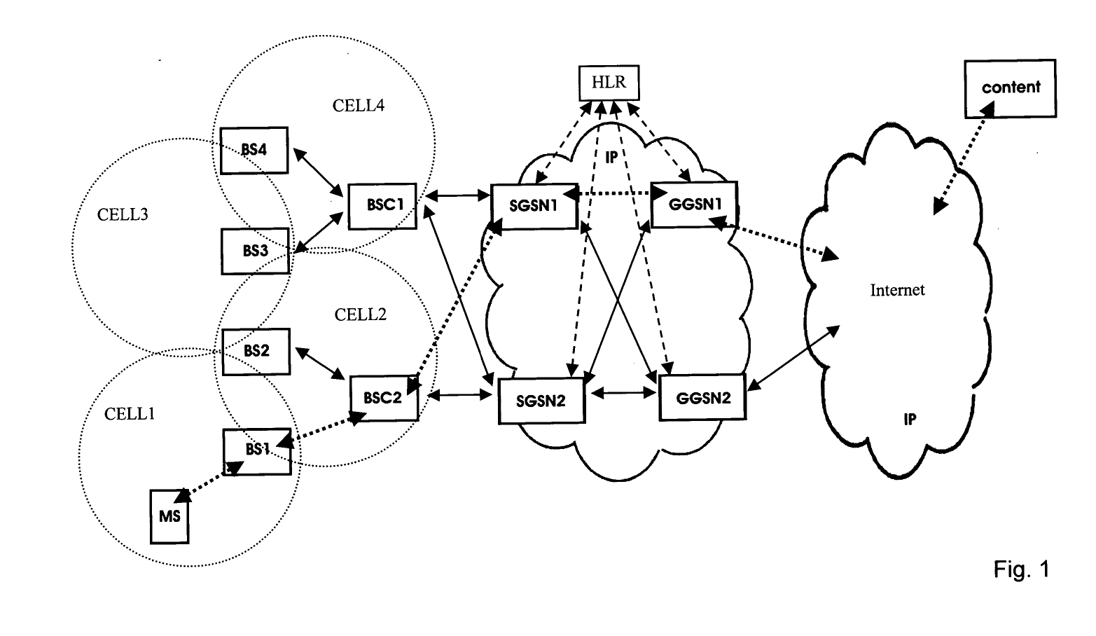

SGSN 40 normally contains more specific context information about every connection it handles. It typically maintains information about the location of the MS 10 with the accuracy of one routing area, in case the MS 10 is in standby state, or of one cell, in case the MS 10 is in ready state. When receiving a LLC frame from the BSC 30, the SGSN 40 generally identifies the mobile station as MS 10 that has sent the packet. With the help of this information, the NSAPI included in the packet and/or the SGSN context information at SGSN 40 concerning the MS 10, the SGSN 40 usually decides that the user data packet included in the SNDCP packet is to be sent to a certain gateway GPRS support node (GGSN). In the case illustrated in FIG. 1, all packets coming from SGSN 40 are normally forwarded to GGSN 50. The context information also typically contains the tunnel identifier (TID), which generally identifies the link for this MS 10 between SGSN 40 and GGSN 50. SGSN 40 commonly generates a GPRS tunneling protocol (GTP) packet, usually including the user data packet, the address of the GGSN 50 and the TID, and normally sends it to GGSN 50.

When receiving the GTP packet, GGSN 50 generally knows, based on the TID and/or the GGSN context information at GGSN 50, that mobile station MS 10 has sent the packet. GGSN 50 then typically sends the IP packet to content server 70, normally via the external packet data network which, in FIG. 2, is the IP based Internet 60.

When replying, content server 70 generally sends a mobile terminated (MT) IP packet addressed to the IP address 232.232.232.232 of the MS 10. Based on the IP address of the MS 10, the IP packet is usually first routed to the GGSN 50 via the Internet 60. Based on the GGSN context information, GGSN 50 normally knows that the address belongs to the MS 10, that the MS 10 is handled by SGSN 40, and/or that the connection between GGSN 50 an MS 10 is identified in the SGSN 40 with a certain TID. Based on this, GGSN 50 usually sends SGSN 40 a GTP packet including the IP packet sent by the content server 70 and/or the certain TID.

In the SGSN 40, the TID of the GTP packet is normally used to derive the routing area RA, the cell identity CELLID, TLLI, and/or NSAPI. If the cell identity of the cell where the MS 10 is located is not known, the MS 10 is typically paged in all the cells of the routing area. NSAPI and TLLI are usually included together with the user data in an LLC frame which is then normally sent to the MS 10 through right BSC 30. The right BSC 30 is generally derived from the cell identity CELLID, which is typically indicated in the BSC 30 in the header of the base station subsystem GPRS protocol (BSSGP). The BSC 30 normally forwards the LLC frame to the MS 10 via BS 20 and the MS 10 commonly decapsulates the IP packet from the LLC frame.

The air interface, or radio connection, between the MS 10 and the BS 20 is, in most situations, the bottleneck of the whole data path from content server 70 to MS 10. First, the data transport capacity of a certain cell of the radio access network is usually constrained. Further, the possible data flow rate and/or data transport capacity on the air interface of the radio access network generally also depends on the environmental factors, at least when the mobile client MS 10 is moving. Furthermore, congestion of the cell, in other words, when, in normal situations, more then one client has to share the data transport capacity of the accessed network node, also commonly influences the data rate on a certain connection of a cell. That usually results in the air interface of radio access networks being a continuously changing bit pipe.

One representative method for dealing with the varying bit pipe of the radio interface between MS 10 and BS 20 is to buffer data packets in the respective SGSN. For example, BSSGP Flow Control typically tries to keep BSC 30 from overloading. SGSN 40 commonly controls flow control by buffering packets if those cannot be sent to BSC 30. If buffers fill too much, SGSN 40 usually drops packets, for example, by utilization of random early detection (RED). However, packet dropping is not always a desired alternative to preempt congestion, since, in certain cases, this will be experienced by the user of MS 10 by a decrease in quality of service.

To relieve that problem, a performance enhancing proxy (PEP) functionality may be used in the GGSN 50 itself or, as shown in FIG. 2, in an adjacent entity, PEP 100, usually between the GGSN 50 and the internet 60. Such PEP functionality may optimize the data transfer. However, it is generally very difficult if the PEP functionality does not even know estimates of a possible leak rate with respect to a certain mobile station. In addition, the leak rate normally changes and varies a great deal due to congestion situations in the radio access network. For example, at one time, MS 10 may experience 30 kbit/s throughput, but the very next moment, call server (CS) side may steal all time slots (TSL) from the cell and throughput at MS 10 may be decreased to as low as zero.

According to certain embodiments of the present invention, by sending certain optimization information immediately to the PEP 100 and/or a TCP optimizations mechanism provided by a PEP functionality in the GGSN 50 itself, congestion situations may be dealt with faster and long breaks in data transfer will typically be avoided.

Accordingly, the PEP 100 or GGSN 50 normally receives various types of pre-processed information from SGSN 40 and/or from BSC 30 in the access network. Optimization information interesting for the data transport optimization may include, for example, a mobile station status commonly including mobile station leak rate, mobile station location, for example, cell ID and/or some other location information, some activity information and/or MS Radio Access Capability, for example, possible access network support such as, but not limited to, GPRS and/or UMTS capability, and/or dual band capability, and/or mobile terminal capability such as, but not limited to, browser type or screen size. Optimization information interesting for the data transport optimization may also include a cell status, commonly including cell load, cell leak rate, possible congestion indication, cell capability, for example, as available in the enhanced data GSM environment (EDGE). Optimization information interesting for the data transport optimization may further include SGSN and BSC or RNC buffer loads and/or overload/congestion status

In the GPRS network according to certain embodiments of the invention, BSC 30 reports normally flow control information to SGSN 40, which is explained in detail in the Standard R5/R4/R99 of 3GPP TS 48.018 concerning the BSS GPRS Protocol (BSSGP). SGSN 40 may forward this information, usually after being slightly modified according to certain embodiments of the present invention, to GGSN 50.

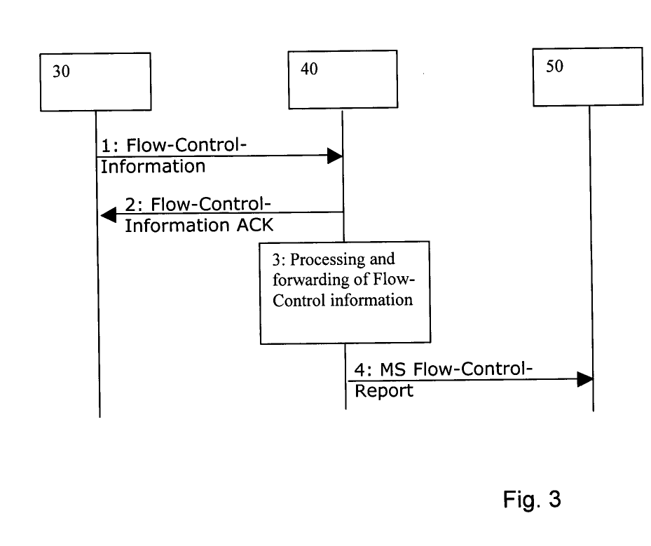

The processing and signaling diagram in FIG. 3 shows, in timely order, the steps usually taken when optimization information from the BSC 30 is forwarded to the SGSN 40 and/or from SGSN 40, typically after processing to the GGSN 50. Accordingly, in a first step 1, “Flow-Control-Information” is generally sent from the BSC 30 to the SGSN 40. After the SGSN 40 has received the “Flow-Control-Information” it commonly sends, in Step 2, an acknowledge signal “Flow-Control-Information-ACK” to the BSC 30. In step 3 the SGSN 40 normally processes the received flow control information according to certain embodiments of the present invention, in other words, it modifies the content slightly, commonly by dropping optional and/or conditional elements, which will be described further below. Then, in step 4, the SGSN 40 typically forwards the modified flow control information as a “MS-Flow-Control-Report” to the right GGSN 50. The GGSN 50 then generally gives applicable information to the performance enhancement proxy (PEP) 100 for adapting the data flow accordingly (not shown in FIG. 3), or uses the optimization information by itself, in case the performance enhancement proxy functionality is contained in the GGSN 50.

For example, Flow-control-MS PDU normally informs, usually with the flow control mechanism at the SGSN 40, of the status of an MS's maximum acceptable throughput on the Gb interface, in other words, the connection from SGSN 40 to the base station subsystem typically including BSC 30 and BS 20. The Gb interface is also explained in detail in the Standard R5/R4/R99 of 3GPP TS 48.018.

In the following tables, 1A to 1C, the representative content of Flow-Control-BVC PDU (table 1A), Flow-Control-MS PDU (table 1B), and Flow-Control-PPFC PDU (table 1C) is shown, wherein M means “mandatory”, C means “conditional”, and 0 means “optional” for the respective information element. The encoding scheme of each information element is given by TLV, which means “Type-Length-Value”, and V, which means “Value (fixed length)”.

TABLE 1A
FLOW-CONTROL-BVC PDU content

| Information | | | | |
|---|---|---|---|---|
| elements | Type/Reference | Presence | Format | Length |
| PDU type | PDU type/11.3.26 | M | V | 1 |
| Tag | Tag/11.3.34 | M | TLV | 3 |
| BVC Bucket | BVC Bucket Size/11.3.5 | M | TLV | 4 |
| Size | | | | |
| Bucket Leak | Bucket Leak Rate/11.3.4 | M | TLV | 4 |
| Rate | | | | |
| Bmax default | Bmax default MS/11.3.2 | M | TLV | 4 |
| MS | | | | |
| R_default_{—} | R_default_MS/11.3.32 | M | TLV | 4 |
| MS | | | | |
| Bucket_Full | Bucket_Full | C | TLV | 3 |
| Ratio | Ratio/11.3.46 | | | |
| BVC | BVC | O | TLV | 4 |
| Measurement | Measurement/11.3.7 | | | |

TABLE 1B
FLOW-CONTROL-MS PDU content

| Information elements | Type/Reference | Presence | Format | Length |
|---|---|---|---|---|
| PDU type | PDU type/11.3.26 | M | V | 1 |
| TLLI | TLLI/11.3.35 | M | TLV | 6 |
| Tag | Tag/11.3.34 | M | TLV | 3 |
| MS Bucket Size | MS Bucket Size/ | M | TLV | 4 |
| | 11.3.21 | | | |
| Bucket Leak rate | Bucket Leak rate/ | M | TLV | 4 |
| | 11.3.4 | | | |
| Bucket_Full Ratio | Bucket_Full | C | TLV | 3 |
| | Ratio/11.3.46 | | | |

TABLE 1C
FLOW-CONTROL-PFC PDU content

| Information | | | | |
|---|---|---|---|---|
| elements | Type/Reference | Presence | Format | Length |
| PDU type | PDU type/11.3.26 | M | V | 1 |
| TLLI | TLLI/11.3.35 | M | TLV | 6 |
| Tag | Tag/11.3.34 | M | TLV | 3 |
| MS Bucket Size | MS Bucket Size/ | O | TLV | 4 |
| | 11.3.21 | | | |
| Bucket Leak rate | Bucket Leak rate/ | O | TLV | 4 |
| | 11.3.4 | | | |
| Bucket_Full Ratio | Bucket_Full | O | TLV | 3 |
| | Ratio/11.3.46 | | | |
| PFC flow control | PFC flow control | M | TLV | |
| parameters | parameters/11.3.68 | | | |

From the tables it is clear, that instead of simply forwarding flow control messages by the SGSN 40 alike the Flow-Control-BVC PDU (table 1A), the Flow-Control-MS PDU (table 1B), or the Flow-Control-PPFC PDU (table 1C), there are modifications possible. Therefore, the SGSN 40 commonly processes the messages and/or applies some changes to the forwarded, less necessary, optional and/or conditional information elements.

In other words, SGSN 40 typically drops less necessary information and generally puts more useful information to the content of the flow control message(s). For example, it may include MS and/or PDP Context identifiers, for example, international mobile subscriber identifier (IMSI), tunnel endpoint identifier (TEID), packet flow identifier (PFI), cell ID, etc., to the message(s). Further, it may combine BSSGP virtual connection (BCV) Bucket Size, BCV Bucket Leak Rate, and/or the information of all or selected subsets of mobile stations located in the cell, when informing GGSN 50 about the cell situation.

According to certain embodiments of the present invention, there are more alternatives for optimizing the throughput and/or response times in the access network by GGSN 50 and/or by the performance enhancement proxy 100. First, the MS/PFC/BVC Flow control information (received from BSC 30) may, in addition, be used for transport optimization purposes for each client, in other words, subscriber and/or, for example, each TCP flow. Second, in case of BVC “congestion”, GGSN 50 may be notified, for example, in at least the following cases: when call server (CS) side steals major part of time slots, when BVC is blocked and/or when other internal errors happen, and/or when the air interface is, for some reason, stuck. A notification will normally be sent with a list of MS or TEID/PDP context which are usually located in the congested radio access cell. Third, in the case of MS/PFC “congestion”, GGSN 50 may be notified, for example, when MS and/or PFC leak rate increases or decreases more than a predetermined value, for example, 10%, and/or when IMSI or PDP context identifier, for example, PFI or TEID, will be attached to the message.

According to certain embodiments of the present invention, the mobile stations leak rate is delivered to GGSN 50. To that effect, SGSN 40 generally simply sends IMSI and/or TEID with the MS leak rate and/or packet flow context (PFC) leak rate to GGSN 50, as shown in table 2 below.

TABLE 2

| | |
|---|---|
| PDP context identifier | TEID (or PFI) |
| Leak Rate (per MS or PDP | MS or PFC Leak |
| context) | rate (e.g. 20 kbps) |

According to other embodiments of the present invention, the cell identifier and/or a mobile station information is delivered to GGSN 50. SGSN 40 usually receives indication from BSC 30 if the BVC Leak rate changes dramatically. It may also, optionally, send this message to GGSN 50 in a little bit different form. Such a message may be called, for instance, “Cell Congestion Notification” (CCN). The CCN Message may carry a cell identifier and/or a list of mobiles, in other words, IMSI's or TEID's, in the radio access cell.

When SGSN 40 notices that the BVC leak rate has decreased or increased more than, for instance, a certain trigger value, for example, 20%, from its previous value, a notification to GGSN 50 may be sent. The notification generally contains a cell identifier, IMSI or TEIDs in order that MS or PDP context may be identified in the GGSN 50 and/or PEP 100. It is generally understood that the trigger value may be a network operator configurable as, for example, the one described above.

In other embodiments of the present invention, SGSN 40 commonly sends the cell identifier and/or the MS leak rate with a list of mobile stations in the radio access cell to GGSN 50. This information usually allows GGSN 50 to select some of the contexts and/or mobile stations, respectively, which are allowed to transmit data when the cell is very congested. For instance, packets from visiting clients, in other words, clients not being subscribers of the operator of the access network, may be downgraded and/or discarded. It is typically highly preferable, and in some cases needed, for SGSN 40 to manage a special table for each cells it handles. The table may have the format as shown in table 3 below.

TABLE 3

| | |
|---|---|
| Cell situation | e.g. +/− 20% |
| changed | |
| Current Cell Leak | x kbps |
| Rate | |
| Mobiles in cell | IMSI's of each mobile located in cell (MS list may |
| | include another two dimensional table, where both |
| | MS identifier and MS leak rate may be present) |

Yet other embodiments of the present invention may be implemented into a telecommunication network, typically including a GPRS network, as will be explained. Generally, only the network elements are discussed which are somehow involved in the data transport which is to be optimized. For better structural illustration, a representative implementation is described with references to FIG. 2.

With respect to the base station controller BSC 30 of the GPRS network, BSC 30 does not generally need any changes at all. Therefore, BSC 30 typically just reports flow control information, as previously discussed.

The gateway GPRS support node, GGSN 50 commonly receives information from a mobile station, MS 10, in a proprietary fashion. Such information generally includes MS and/or PDP context identifiers, often with leak rate information. In addition, cell information may be sent to GGSN 50. When receiving load information from the serving GPRS support node, SGSN 40, the GGSN 50 usually forwards the information to the PEP entity, PEP 100, in case such functionality is not implemented within the GGSN 50 itself. In addition, GGSN 50 and/or PEP 100 may prioritize traffic flows of a single user and/or between different users so that higher priority flows get bandwidth whereas lower priority flows are downgraded. In addition, GGSN 50 may downgrade PDP context QoS, especially for roaming subscribers, in other words, visiting clients. GGSN 50 may also detach subscribers if no resources are available for them. Furthermore, GGSN 50 may optimize the transport layer. In order to do so, it may split transport protocol, for example, TCP, and/or utilize wireless profiled TCP (WTCP) and/or some modified TCP between MS and GGSN and a normal TCP towards TCP server.

As for the information exchange between SGSN 40 and GGSN 50 over the Gn interface, a private extension information element (IE) may be used. Such an IE may be included in any GTP signaling message. Further, one signaling message may include more than one IE, generally of the Private Extension type. The data structure of the private extension IE may be freely designed. A useful design includes the IE to an update PDP context request. It is also generally possible to create a new message type for it.

Since flow control has not typically been implemented into today's radio access networks (RAN), the RAN is not commonly able to report leak rates, etc., in as much detail as the BSC 30 in the 2G network systems. However, a radio network controller (RNC) may report, for instance, PDCP buffer loads to GGSN 50.

In currently available GPRS networks, 2G-SGSN usually receives flow control information from BSS. The flow control information normally includes, as mentioned above, MS, BVC, and/or PFC flow control messages. According to certain embodiments of the present invention, in addition, SGSN 40 may send information of its Gb buffer (TC and THP) load ratios. Further, SGSN 40 often sends the information in a simple format to GGSN 50. Information may be sent in a group of single messages or in one combined message. SGSN 40 itself generally uses flow control information, as before. Furthermore, SGSN 40 may downgrade PDP context QoS, especially for roaming subscribers that use GGSN 50 in another public land mobile network (PLMN). SGSN 40 may also detach subscribers if no resources are available for them.

In a 3G-SGSN, the 3G-SGSN usually needs only to forward proprietary information from RNC to GGSN 50. Transferred information will be defined later. If GGSN 50 is in vPLMN, 3G-SGSN may be forced to decrease QoS or, in a typically less desirable and sometimes worst case, detach MS.

As for the PEP functionality, the PEP functionality usually contained either in the GGSN 50 or as a sole entity PEP 100 adjacent to the GGSN 50, is commonly the actual place for traffic optimization. It typically may adjust application behavior, thereby enabling it to perform better in a changed environment. It may also generally buffer flow when such buffering is seen as necessary and may decrease the received leak rate from the server accordingly. Furthermore, GGSN 50 may also optimize the transport layer. For that purpose, it may split transport protocol, for example, TCP, and may, for example, utilize WTCP between MS 10 and GGSN 50 and normal TCP towards the TCP server.

Certain embodiments of the present invention have introduced methods for data transport optimization in a telecommunication network, in particular, for implementation in a packet switched telecommunication network, such as, but not limited to, a GPRS, a CDMA2000 and/or a UMTS telecommunication network, or WLAN. The network typically includes at least a first access node, which usually provides access to the telecommunication network. Commonly, at least a first optimization node, normally including a performance enhancement proxy functionality is often located between a core of the telecommunication network and the at least first access node. Data is commonly sent, at least from the core, in the direction of the at least first access node, from which the data is generally sent to at least a first client, usually having access to the telecommunication network via a link to the access node. The link usually has a varying data transport capacity. The method according to certain embodiments of the present invention normally includes at least the following steps: Optimization information indicating the actual available data transport capacity of the at least first access network or link is usually monitored consecutively. The optimization information is commonly forwarded to the at least first optimization node. The data flow rate from the core to the at least first access node is generally adapted to the monitored data transport capacity, usually by the performance enhancement proxy functionality in the optimization node.

One having ordinary skill in the art will readily understand that the embodiments of the invention, as discussed above, may be practiced with steps in a different order, and/or with hardware elements in configurations which are different than those which are disclosed. Therefore, although the invention have been described based upon these embodiments, it will be apparent to those of skill in the art that certain modifications, variations, and/or alternative constructions would be apparent, while remaining within the spirit and scope of the invention. In order to determine the metes and bounds of the invention, therefore, reference should be made to the appended claims.

We claim:

1. A method for data transport optimization in a telecommunication network with at least a first access node providing access to the telecommunication network, and at least a first optimization node, which comprises a performance enhancement proxy functionality and which is located between a core of the telecommunication network and the at least first access node, wherein data is sent at least from the core in the direction of the at least first access node, from which the data is sent to at least a first client having access to the telecommunication network via an access link to the at least first access node, and wherein the access link comprises a varying data transport capacity, the method comprising the following steps:
consecutively monitoring optimization information which indicates the actual available data transport capacity of the access link;
forwarding the optimization information to the at least first optimization node; and
adapting the data flow rate from the core to the access link with respect to the monitored data transport capacity by the performance enhancement proxy functionality in the optimization node.

2. The method according to claim 1, wherein, in the consecutively monitoring step, the access link comprises an access network of the telecommunication network having a varying data transport capacity.

3. The method according to claim 1, wherein, in the consecutively monitoring step, the access link comprises a radio connection having a varying data transport capacity.

4. The method according to claim 1, wherein, in the consecutively monitoring step, the at least first client comprises a mobile station, the at least first access node comprises a base station of a base station subsystem, and the coverage area of a base station defines a radio access cell.

5. The method according to claim 4, wherein, in the consecutively monitoring step, the at least first optimizing network node comprises a gateway support node, which comprises the performance enhancement proxy functionality.

6. The method according to claim 4, wherein, in the consecutively monitoring step, a gateway support node is located between the base station subsystem and the at least first optimizing network element.

7. The method according to claim 5, wherein, in the consecutively monitoring step, at least a first serving support node is located between the gateway support node and the base station subsystem.

8. The method according to claim 6, wherein, in the consecutively monitoring step, at least a first serving support node is located between the gateway support node and the base station subsystem.

9. The method according to claim 1, wherein, in the consecutively monitoring step, the telecommunication network comprises a packet switched telecommunication network, in particular a GPRS, a CDMA2000 or a UMTS telecommunication network, or WLAN.

10. The method according to claim 7, wherein the step of consecutively monitoring the optimization information is performed by the serving network node.

11. The method according to claim 8, wherein the step of consecutively monitoring the optimization information is performed by the serving network node.

12. The method according to claim 4, wherein the step of consecutively monitoring the optimization information is performed by the base station subsystem.

13. The method according to claim 1, wherein the step of adapting the data flow rate is performed by downgrading or discarding packets from visiting clients.

14. The method according to claim 1, wherein the method for data transport optimization further comprises the step of individually adapting the data flow rate for each or selected clients connected to the at least first access node.

15. The method according to claim 5, wherein the step of forwarding the optimization information comprises implementing the optimization information into standard messages used between the network elements of the telecommunication network by processing the standard messages in the base station subsystem or in the at least first serving support node of the telecommunication network.

16. The method according to claim 6, wherein the step of forwarding the optimization information comprises implementing the optimization information into standard messages used between the network elements of the telecommunication network by processing the standard messages in the base station subsystem or in the at least first serving support node of the telecommunication network.

17. The method according to claim 4, wherein, in the consecutively monitoring step, the optimization information comprises information about congestion of the radio access cell of the at least first access node.

18. The method according to claim 4, wherein the forwarding the optimization information step is performed by sending a notification with a list comprising data which identifies all or selected clients that are located in the radio access cell of the at least first access node.

19. The method according to claim 9, wherein, in the consecutively monitoring step, the optimization information comprises flow control information about the mobile station, packet flow control information, or flow control information about a virtual connection of the base station subsystem GPRS protocol.

20. The method according to claim 9, wherein the step of forwarding the optimization information is performed when for the access link a predetermined number of time slots is not available.

21. The method according to claim 9, wherein the step of forwarding the optimization information is performed when a virtual connection of the base station subsystem GPRS protocol is blocked.

22. The method according to claim 1, wherein the step of forwarding the optimization information is performed when an internal error happens, which decreases the data transport capacity of the access link.

23. The method according to claim 1, wherein the step of forwarding the optimization information is performed when the access link is stuck.

24. The method according to claim 1, wherein the step of forwarding flow control information takes place when a data leak rate or a packet data flow control leak rate of the access link increases or decreases more than by a predetermined value.

25. The method according to claim 24, wherein, in the step of forwarding flow control information, an international mobile subscriber identifier (IMSI) or packet data control (PDP) context identifier is attached to the optimization information.

26. A network element for data transport optimization in a telecommunication network having a performance enhancement proxy functionality and being located between a core of the telecommunication network and an at least first access link of the telecommunication network which is arranged for receiving optimization information, which indicates the actual available data transport capacity of the at least first access link and for adapting a data flow rate from the core directed to the at least first access link to the monitored data transport capacity of the access link.

27. A network element according to claim 26, wherein the network element comprises a gateway support node of a packet switched telecommunication network, in particular a GPRS, a CDMA2000 or a UMTS telecommunication network, or WLAN.

28. A network element according to claim 26, wherein the network element comprises a performance enhancement proxy located between a core of the telecommunication network and a gateway support node of a packet switched telecommunication network, in particular a GPRS, a CDMA2000 or a UMTS telecommunication network, or WLAN.

29. A telecommunication network capable of data transport optimization therein, comprising at least a first access node providing access to the telecommunication network, and at least a first optimization node, which comprises a performance enhancement proxy functionality and which is located between a core of the telecommunication network and the at least first access node, wherein data is sent at least from the core in the direction of the at least first access node, from which the data is sent to at least a first client having access to the telecommunication network via an access link to the at least first access node, and wherein the access link comprises a varying data transport capacity, the network further comprising:
means for consecutively monitoring optimization information which indicates the actual available data transport capacity of the access link;
means for forwarding the optimization information to the at least first optimization node; and
means for adapting the data flow rate from the core to the access link with respect to the monitored data transport capacity by the performance enhancement proxy functionality in the optimization node.

30. A telecommunication network comprising:
a core;
a first access link having a monitored data transport capacity; and
a network element for data transport optimization in the network, the network element having a performance enhancement proxy functionality and being located between the core and the first access link, the network element being arranged for receiving optimization information, which indicates the actual available data transport capacity of the first access link and for adapting a data flow rate from the core directed to the first access link to the monitored data transport capacity of the access link.
